(19) United States
(12) Patent Application Publication
(10) Pub. No.: US 2024/0402695 A1
(43) Pub. Date: Dec. 5, 2024

(54) PLANT OPERATION ASSISTANCE DEVICE

(71) Applicant: Mitsubishi Electric Corporation, Tokyo (JP)

(72) Inventors: Yohei UENO, Tokyo (JP); Masayo NAKAGAWA, Tokyo (JP); Ken IMAI, Tokyo (JP); Emi YONEDA, Tokyo (JP); Kotaro SANAI, Tokyo (JP); Kazuhiro ODA, Tokyo (JP)

(73) Assignee: Mitsubishi Electric Corporation, Tokyo (JP)

(21) Appl. No.: 18/697,738

(22) PCT Filed: Oct. 19, 2021
(86) PCT No.: PCT/JP2021/038640

§ 371 Date: Apr. 2, 2024

(51) Int. Cl. G05B 23/02

(52) U.S. Cl. CPC G05B 23/0216; G05B 23/0272; G05B 2223/02

(57) ABSTRACT

A plant operation assistance device is provided which provides a display interface capable of reducing an operator's load in analysis work. The plant operation assistance device includes a data selection means, a data selection database, a measurement data database, a display data collection unit, and a data analysis graph creation unit. The data selection database records information on the operation performed by an operator through the data selection means. The data analysis graph creation unit creates a data analysis graph for displaying data of a second graph related to operator selected data of a first graph.

### TECHNICAL FIELD

The present disclosure relates to a plant operation assistance device that performs detection of an abnormal state in a plant, factor analysis when an abnormality occurs, and the like.

### BACKGROUND ART

In a large-scale plant for electric power, water and sewage, or the like, a monitoring and control system is often constructed for the purpose of grasping the situation of the entire plant and detecting an abnormal state at an early stage. The monitoring and control system collects measurement values measured through sensors attached to respective facilities of a plant, and collectively monitors the measurement values on a display device called a central monitoring monitor.

In general, such a large-scale plant is constituted by a combination of a plurality of manufacturing processes, and it is known that the large-scale plant exhibits a complicated behavior such that an output change of a certain facility sequentially affects an upper process and a lower process. Therefore, an operator overviews not only the presence or absence of alarms issued by the monitoring and control system but also the changes in the measurement values, and detects the occurrence of an abnormality by comparing them with a plurality of measurement values.

In addition, as one of the tasks performed by the operator and the facility manager, there is factor analysis in a case where an abnormality occurs. The factor analysis is to investigate a fundamental factor causing an abnormal behavior of the plant. Specifically, by analyzing the measurement value data collected by the monitoring and control system using a method such as statistical analysis, the presence or absence of an abnormal state, the relationship of abnormality propagation, and the like are quantitatively evaluated. For example, as a method for assisting the factor analysis, a method is disclosed in which a threshold value for determining whether the current plant is normal or abnormal is automatically calculated in accordance with a calculation method registered in advance (For example, refer to Patent Document 1).

### PRIOR ART DOCUMENT

### Patent Document

[Patent Document 1] Japanese Unexamined Patent Publication No. 2015-172945

### SUMMARY OF INVENTION

### Problems to be Solved by the Invention

For an event that cannot be directly measured by a sensor, such as deterioration of a plant wall surface or clogging of a filter, it is necessary to infer the cause from a measurement value change of the entire system, a propagation state of an abnormal state, or the like. Therefore, in the above-described method in which a threshold value is automatically calculated according to the calculation method registered in advance, there is a possibility that an abnormal state cannot be accurately detected when an event with few occurrences that cannot be directly measured by the sensor occurs.

Such an event for which no detection method has been established requires manual analysis by the operator, and a high analysis technique and a large amount of labor are required to determine a factor from a large amount of data.

The present disclosure is made to solve the above-described problem, and an object thereof is to provide a display interface capable of reducing a load on the operator in analysis work.

### Means for Solving the Problems

A plant operation assistance device according to the present disclosure includes a data selection means for an operator to select an arbitrary data range of a first graph in the first graph and a second graph displayed on a display to be operated by the operator, a data selection database to record information on an operation of the operator including selection of the data range performed through the data selection means, a measurement data database to accumulate measurement data measured by a measurement device, a display data collection unit to collect the information on the operation recorded in the data selection database and the measurement data arbitrarily selected by the operator from among the measurement data accumulated in the measurement data database, and a data analysis graph creation unit to create a data analysis graph to display data of the second graph related to data of the first graph selected by the operator.

### Advantageous Effects of the Invention

The plant operation assistance device according to the present disclosure has an effect that, when factor analysis is performed on an event that has occurred in a plant and for which no detection method has been established, the load on the operator in the analysis work can be reduced.

### BRIEF DESCRIPTION OF THE DRAWINGS

FIG. 1 is a block diagram of a plant operation assistance device according to Embodiment 1 of the present disclosure.

FIG. 2 is a hardware configuration diagram of the plant operation assistance device according to Embodiment 1 of the present disclosure.

FIG. 3 is a diagram schematically showing an example of a recording method of a data selection history database according to Embodiment 1 of the present disclosure.

FIG. 4 is a diagram showing a display example of a data analysis graph created by a data analysis graph creation unit according to Embodiment 1 of the present disclosure.

FIG. 5 is a diagram schematically showing an example of guidance display in an analysis procedure creation unit according to Embodiment 1 of the present disclosure.

FIG. 6 is a block diagram of a plant operation assistance device according to Embodiment 2 of the present disclosure.

FIG. 7 is a diagram schematically showing an example of a screen change at a time of switching display data according to Embodiment 2 of the present disclosure.

FIG. 8 is a block diagram of a plant operation assistance device according to Embodiment 3 of the present disclosure.

FIG. 9 is a diagram schematically showing an example of a recording method of analysis result database according to Embodiment 3 of the present disclosure.

FIG. 10 is a guidance display example of the plant operation assistance device according to Embodiment 3 of the present disclosure.

FIG. 11 is a block diagram of a plant operation assistance device according to Embodiment 4 of the present disclosure.

### EMBODIMENTS FOR CARRYING OUT THE INVENTION

Hereinafter, embodiments will be described in detail with reference to figures. Note that, the embodiments described below are examples. In addition, the embodiments can be implemented in combination as appropriate.

### Embodiment 1

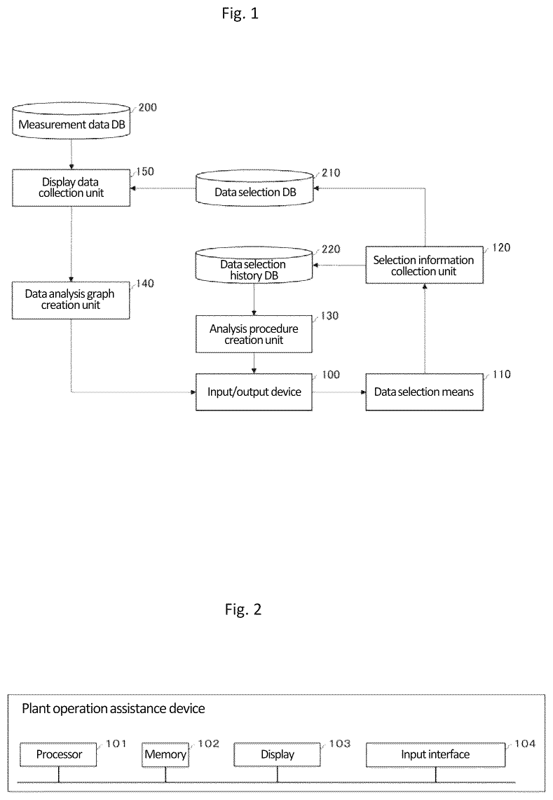

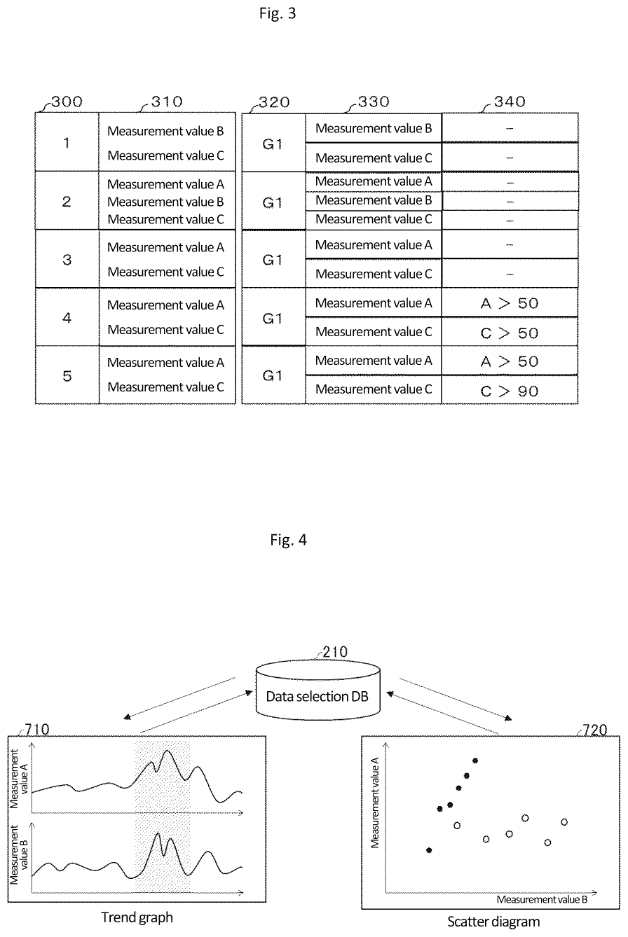

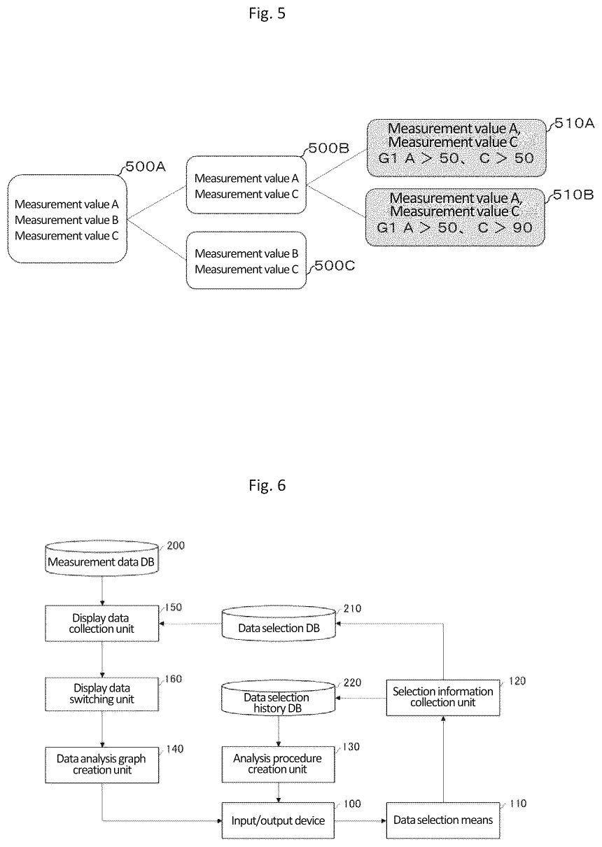

FIG. 1 is a block diagram of a plant operation assistance device according to Embodiment 1 of the present disclosure. FIG. 2 is a hardware configuration diagram of the plant operation assistance device according to Embodiment 1 of the present disclosure. FIG. 3 is a diagram schematically showing an example of a recording method of a data selection history database according to Embodiment 1 of the present disclosure. FIG. 4 is a diagram showing a display example of a data analysis graph created by a data analysis graph creation unit according to Embodiment 1 of the present disclosure. FIG. 5 is a diagram schematically showing an example of guidance display in an analysis procedure creation unit according to Embodiment 1 of the present disclosure.

The plant operation assistance device shown in FIG. 1 includes an input/output device 100 to display a graph, a data selection means 110 to select an arbitrary data range in the graph, a selection information collection unit 120 to collect operation information, a data selection database (DB) 210 and the data selection history database (DB) 220 to record the collected operation information, a measurement data database (DB) 200 to accumulate measurement data measured by a measurement device, a display data collection unit 150 to collect the operation information recorded in the data selection database 210 and the measurement data accumulated in the measurement data database 200, the data analysis graph creation unit 140 to create a data analysis graph in which data of another graph related to the selected data is displayed, and the analysis procedure creation unit 130 to create guidance based on the history of the operation information recorded in the data selection history database 220.

FIG. 2 is a hardware configuration diagram of the plant operation assistance device. The plant operation assistance device includes a processor 101 such as a control processing unit (CPU), a memory 102 such as a random access memory (RAM), a display 103, and an input interface (I/F) 104. The selection information collection unit 120, the analysis procedure creation unit 130, the data analysis graph creation unit 140, and the display data collection unit 150 are realized by the processor 111 executing a program stored in the memory 102. However, these may be realized by, for example, a plurality of processors 101 in cooperation with each other.

The data selection means 110 is a function of arbitrarily selecting data of interest to the operator by a mouse operation or the like in the graph displayed on the input/output device 100. The graph referred to here may be any type of graph such as a trend graph or a scatter diagram as long as the operator can arbitrarily select data to perform the factor analysis, and the number of graphs to be displayed is not limited. The input/output device 100 for displaying a graph should be a display device, a display interface, or the like that can display a graph.

The operator directly designates an arbitrary period, upper and lower limit values, and the like on the trend graph of interest by operating the mouse. The operator can also directly designate the data range of interest on the scatter diagram by operating the mouse.

Although the mouse operation has been described as an example of the operation means by which the operator selects arbitrary data on the graph, the data range can also be designated by inputting a numerical expression such as a threshold value or an inequality. In addition, a series of setting operations related to graph display such as a display period in the trend graph and maximum and minimum display ranges in the scatter diagram is included.

Information on the operation including selection of a data range on the graph, performed by the operator using the data selection means 110, is collected by the selection information collection unit 120, and the operation information collected by the selection information collection unit 120 is recorded in the data selection database 210. The operation information of the operator collected by the selection information collection unit 120 is recorded in the data selection database 210 and the data selection history database 220, but only the information on the latest operation performed by the operator is recorded in the data selection database 210.

Explanation will be made using an example. When the operator selects a data range on the graph by operating the mouse cursor, the selection information collection unit 120 extracts the ID and period of the selected data, converts the selected data range into an expression, and collects the expression. Then, the collected operation information is recorded in the data selection database 210. For example, when a range in which the value of the measurement value A exceeds 50 is selected, the inequality “A>50” is recorded in the data selection database 210.

The data selection history database 220 is a function of recording a history of information on data selection operations performed by the operator. FIG. 3 is a diagram schematically showing data selection information recorded in the data selection history database 220.

The data selection information includes display data information 310, a data selection ID 320, data selection content information 330, and data selection range information 340, and is recorded in the data selection history database 220 together with a data selection history ID 300. The display data information 310 is for registering a measurement value used for displaying a graph such as a trend graph and a scatter diagram.

The data selection ID 320 is for managing data selected by the operator on the graph as a group. For example, when a plurality of different data on the graph are selected, they are grouped as G1, G2, and the respective registered contents are recorded.

The data selection content information 330 and the data selection range information 340 record which range of which data on the graph is designated, that is, the selected data information, by each group recorded in the data selection ID 320. Explanation will be made with reference to FIG. 4. In FIG. 4, it is assumed that a trend graph in which measurement values A and measurement values B are displayed and a scatter diagram having the measurement values A on the vertical axis and the measurement values B on the horizontal axis are displayed, on the input/output device 100. When the operator designates a shaded range on the trend graph, the measurement values A and the measurement values B are recorded in the display data information 310, and the measurement values A and the measurement values B are recorded in the data selection content information 330. In the data selection range information 340, an inequality corresponding to a range selected by the operator on the scatter diagram is recorded.

The measurement data database 200 is a function for accumulating measurement data measured by a measurement device. The measurement device may be any equipment or means capable of measuring the state of the plant.

The display data collection unit 150 is a function of collecting the latest operation information of the operator recorded in the data selection database 210 and the measurement data accumulated in the measurement data database 200.

The data analysis graph creation unit 140 is a function of creating a data analysis graph in which, when the operator selects arbitrary data on a graph displayed on the input/output device 100, data of another graph related to the selected data is displayed, using the data collected by the display data collection unit 150. FIG. 4 is a diagram showing a display example of the data analysis graph created by the data analysis graph creation unit 140.

Explanation will be made with reference to FIG. 4. A trend graph and a scatter diagram are displayed on the input/output device 100. Two measurement data of the measurement values A and the measurement values B are displayed in the trend graph, and a graph having the measurement values A on the vertical axis and the measurement values B on the horizontal axis is displayed in the scatter diagram. When the operator selects a shaded portion of the trend graph, operation information such as the selected data type and time period is recorded in the data selection database 210. On the other hand, in the scatter diagram, the operation information recorded in the data selection database 210 is referred to, and the display color of the data (marker) related to the data selected by the operator is changed and highlighted. In the scatter diagram of FIG. 4, the white markers are highlighted.

Conversely, when the operator selects arbitrary data (marker) in the scatter diagram, the selection ranges of the measurement values A and the measurement values B are recorded in the data selection database 210. In the trend graph, the display color of the corresponding time period is changed and highlighted according to the selection ranges recorded in the data selection database 210.

FIG. 4 illustrates an example in which the data of another graph related to the selected data is displayed by changing the color, it is not limited to the display by changing the color. Any method may be used as long as the data of another graph related to the selected data is displayed in an emphasized manner; for example, the data may be displayed in a blinking manner.

As described above, when the operator selects data on a graph displayed on the input/output device 100 on the basis of the operation information recorded in the data selection database 210, the data of another graph related to the selected data can also be displayed. This makes it possible to instantaneously check the data of another graph corresponding to the selected data, thereby reducing the workload of the operator in the analysis.

The analysis procedure creation unit 130 creates guidance on the basis of the history of the operation information recorded in the data selection history database 220, and performs guidance display on the input/output device 100. FIG. 5 schematically shows an analysis procedure created by the analysis procedure creation unit 130 on the basis of the history of the data selection information recorded in the data selection history database 220. In the present disclosure, the guidance display means to display, on the input/output device 100, guidance information showing selection procedures and selection operation contents of data recorded in the data selection history database 220.

FIG. 3 shows that the measurement value B and the measurement value C are displayed in Procedure 1, the measurement value A, the measurement value B, and the measurement value C are displayed in Procedure 2, and the measurement value A and the measurement value C are displayed in Procedure 3. In Procedure 4, it is shown that the measurement value A and the measurement value C are displayed and the data ranges of the areas where the measurement value A>50 and the measurement value C>50 are selected. In Procedure 5, it is shown that the measurement value A and the measurement value C are displayed, and the data ranges of the measurement value A>50 and the measurement value C>90 are selected.

On the other hand, in FIG. 5, an operation for additionally displaying data is arranged on the left side, an operation for limitedly displaying data is arranged on the right side, and operation information is displayed in a branching form. This will be described in detail with reference to FIG. 5; starting from Procedure 1 (500C), the measurement value A is newly added in Procedure 2 (500A); thus. Procedure 2 is arranged on the left side of Procedure 1 (display 500C). In Procedure 3 (500B), an operation of deleting the measurement value B from Procedure 2 (500A) is performed; thus. Procedure 3 is arranged on the right side of Procedure 2 (500A). In Procedure 4 (510A) and Procedure 5 (510B), operations of selecting data ranges from among the data in Procedure 3 (500B) are performed; thus, they are arranged on the right side of Procedure 3 (500B), and inequalities indicating the data selection ranges are also displayed.

In FIG. 5, an example of display in a branching form is shown; however, display in a list form, a flowchart form, or the like is also conceivable. As described above, with respect to the operation procedure of the analysis operation performed by the operator, it is possible to classify the works with data addition and limitation operations as divisions and visualize the operation content and the operation procedure. This makes it easier for the operator to grasp the situation from what viewpoint the analysis operation was intended to proceed, and also improves the comprehensiveness of the analysis, and avoids duplication of work in the analysis work.

As described above, in the present embodiment, when the operator performs factor analysis, if the operator selects data on one graph displayed on the input/output device 100, related data is displayed in another graph displayed on the display. In addition, the operation information is recorded, and guidance display of the operation content and the operation procedure is performed. This makes it easy to visualize correlations between a plurality of graphs displayed on the input/output device 100, and it is possible to reduce the number of times in the occurrences of rework and the like by suppressing the mixing of erroneous information. Thus, the workload of the operator in the data analysis can be reduced.

### Embodiment 2

In Embodiment 1, the plant operation assistance device that can reduce the workload of the operator in the data analysis is described. Embodiment 2 shows a plant operation assistance device for solving a problem that it is necessary to repeatedly switch display data in a process in which an operator searches a large amount of measurement value data for data necessary for factor analysis. Specifically, it consists of the plant operation assistance device according to Embodiment 1 with the addition of a display data switching unit 160. The same components as those in Embodiment 1 are denoted by the same reference numerals, and descriptions thereof will be omitted.

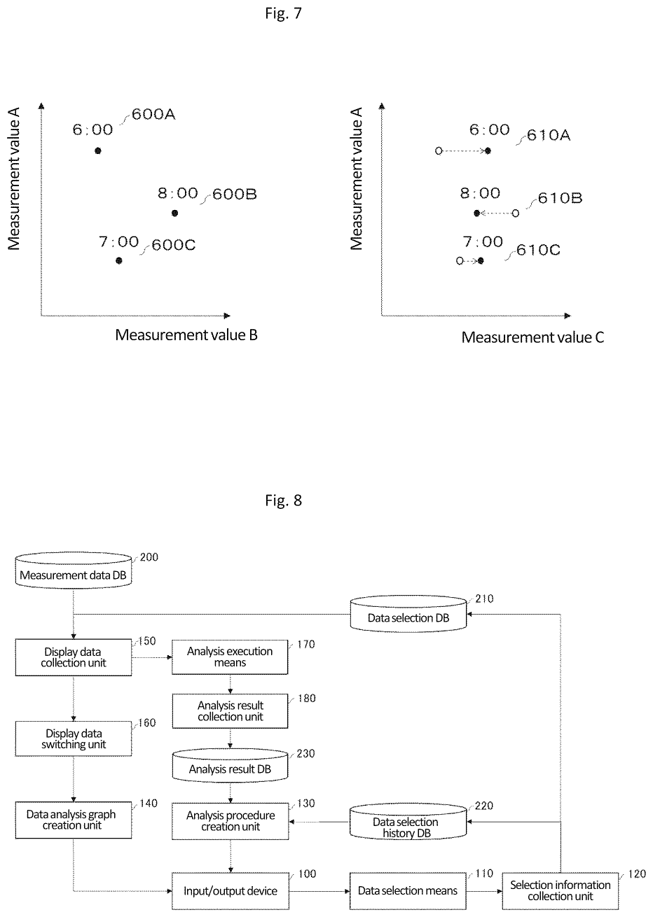

The present embodiment will be explained with reference to FIG. 6 and FIG. 7. FIG. 6 is a block diagram of the plant operation assistance device according to Embodiment 2 of the present disclosure. FIG. 7 is a diagram schematically showing an example of a screen change at a time of switching display data according to Embodiment 2 of the present disclosure.

The display data switching unit 160 is a function of continuously switching display of time-series changes of data displayed on a graph such as a trend graph or a scatter diagram by using an animation method or the like.

The detail will be described with reference to FIG. 7. In FIG. 7, two axes of the measurement value A and the measurement value B are selected, and data at each time is displayed by a black circle marker (data 600A at time 6:00, data 600C at time 7:00, and data 600B at time 8:00). When the operator performs an operation of switching the data on the horizontal axis from the measurement value B to the measurement value C, the position of the data at each time changes (data 610A at time 6:00, data 610C at time 7:00, and data 610B at time 8:00). At this time, the data before switching is represented by a white marker, and the movement data after switching is represented by a black marker. The time-series change of the data from the white marker to the black marker at each time is continuously displayed by the animation method.

FIG. 7 shows that the markers at the time 6:00 and the time 7:00 are moved in the right direction, whereas the marker at the time 8:00 is moved in the left direction, which are continuously displayed by the animation method. From this, it can be understood that the time 8:00 is an outlier because it moves differently from the other data.

Such animation display can also be realized by moving the display camera position in a three-dimensional scatter diagram. For example, in a three-dimensional scatter diagram having the measurement value A and the measurement value B in the planar direction and the measurement value C in the normal direction, the measurement value B and the measurement value C are switched so that the measurement value A and the measurement value C are in the planar direction and the measurement value B in the normal direction.

As described above, by using the animation method, it is possible to obtain an effect that the switching operation of the display data is unnecessary, and it is easy to understand what kind of time-series change has occurred by the switching operation of the data.

### Embodiment 3

In data analysis, as means for quantitatively expressing what kind of distribution or characteristic the data has, there are an average value, a variance value, and a value of a correlation coefficient in statistical analysis, an evaluation value of an objective function in an optimization problem, and the like. When an operator performs an operation such as factor analysis, the operator may give a meaning using a quantitative evaluation value together with a feature on a distribution of a graph.

Embodiment 3 shows a plant operation assistance device that reduces the workload of the operator's data analysis work in data analysis using the quantitative evaluation value. The present embodiment is configured by adding an analysis execution means 170, an analysis result collection unit 180, and an analysis result database (DB) 230 to the plant operation assistance device shown in Embodiment 2. The same components as those in Embodiment 2 are denoted by the same reference numerals, and descriptions thereof will be omitted.

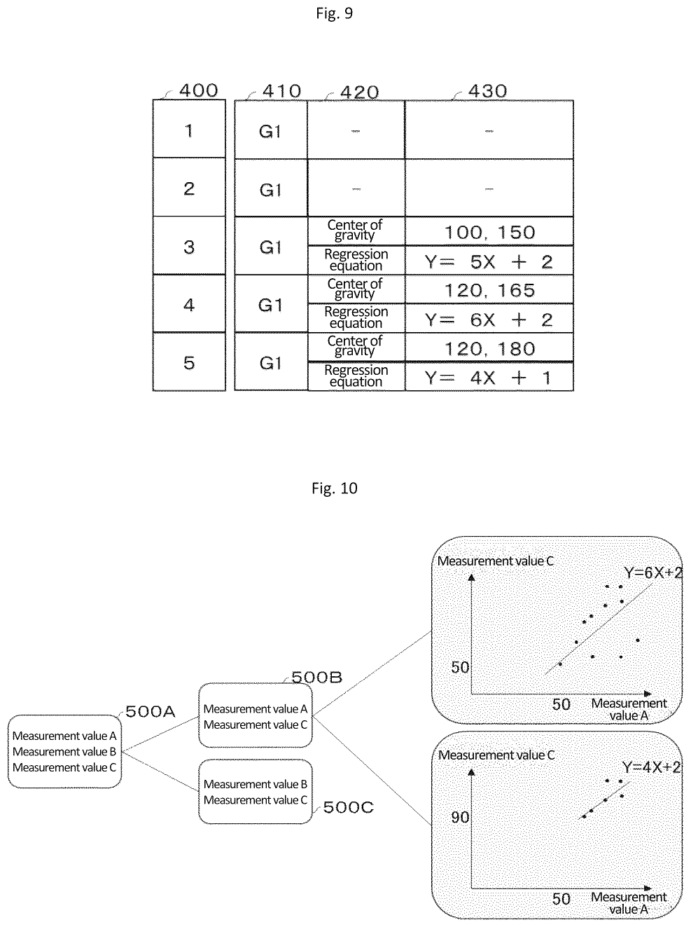

The present embodiment will be described with reference to FIG. 8 to FIG. 10. FIG. 8 is a block diagram of a plant operation assistance device according to Embodiment 3 of the present disclosure. FIG. 9 is a diagram schematically showing an example of a recording method of the analysis result database 230 according to Embodiment 3 of the present disclosure. FIG. 10 is a guidance display example of the plant operation assistance device according to the present embodiment.

The analysis execution means 170 is a function of calculating a correlation between data such as data distribution and data relationship collected by the display data collection unit 150. The correlation of the collected data is calculated by quantitative evaluation using an evaluation value such as an average value or a regression equation of the data.

The analysis result collection unit 180 is a function of classifying the correlation results of the data calculated by the analysis execution means 170 and recording the result in the analysis result database 230. The analysis result database 230 records the analysis result related to the correlation of the data calculated by the analysis execution means 170, that is, the evaluation value such as the average value or the regression equation of the data. The analysis result database 230 records a data selection history ID 400, a data selection ID 410, analysis method name information 420, and analysis result information 430.

Explanation will be made with reference to FIG. 9. The analysis method name information 420 is an analysis method used when the analysis result is calculated in the analysis execution means 170, and is, for example, an average value, a center of gravity, a regression equation, or the like. The analysis result information 430 is the evaluation value representing the analysis result calculated by the analysis execution means 170 using the analysis method.

The data selection history ID 400 and the data selection ID 410 recorded in the analysis result database 230 have the same contents as those recorded in the data selection history database 220. Grouping is performed by the data selection ID 410, and the analysis method name information 420 and the analysis result information 430 are recorded in each group. In the example shown in FIG. 9, the center of gravity and the regression equation of Group 1 (G1) are calculated in each of Procedures 3 to 5 (the data selection history ID 400: 3 to 5). As the selection range of data is limited in the order of Procedure 4 and Procedure 5, the center of gravity and the regression equation are recalculated.

FIG. 5 illustrates, as an example of the guidance information generated by the analysis procedure creation unit 130, an example in which the data selection ranges are displayed by inequalities; however, in the present embodiment, the guidance display is performed on the input/output device 100 by adding evaluation values indicating correlations of the data recorded in the analysis result database 230. FIG. 10 is a guidance display example of the plant operation assistance device according to the present embodiment. As shown in FIG. 10, by performing the guidance display with the evaluation values recorded in the analysis result database 230 added, the data selected by the operator by operation procedure and the evaluation values thereof can be displayed in association with each other. In addition, while a display example using a graph is shown in FIG. 10, a display using text information may be performed as shown in FIG. 5.

As described above, by combining the evaluation value, which is the analysis result related to the correlation of the data, with the data range selected by the operator to perform guidance display, the selection range of the data and the evaluation value can be associated with each other, and it can be quickly determined whether or not the performed data selection is valid. This has an effect of reducing the operator's workload in factor analysis.

### Embodiment 4

In Embodiment 1, a description is given of the plant operation assistance device in which the analysis procedure creation unit 130 performs the guidance display with the data addition and limitation operations as divisions.

In Embodiment 3, the plant operation assistance device is described which performs the guidance display by combining the evaluation value with the data selection range; however, in the process of advancing the detailed analysis, the evaluation values may be classified not only by the combination with the data selection range but also by the used analysis method. The present embodiment shows a plant operation assistance device having a configuration in which an analysis content classification unit 190 for classifying the evaluation values is added to the plant operation assistance device according to Embodiment 3. The same components as those in Embodiment 3 are denoted by the same reference numerals, and descriptions thereof will be omitted.

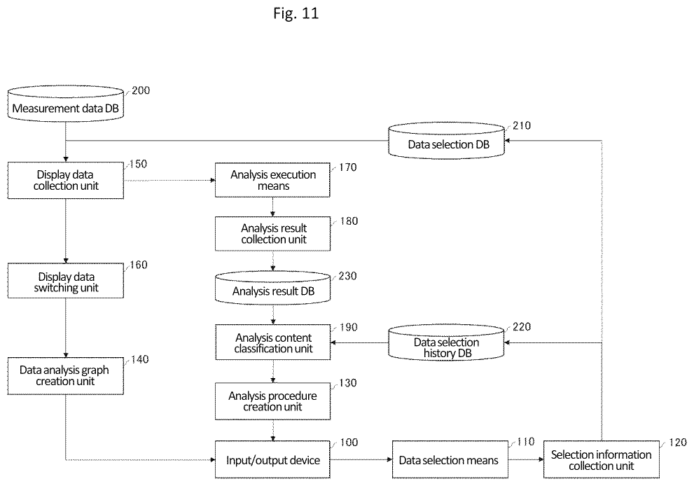

FIG. 11 is a block diagram of the plant operation assistance device according to Embodiment 4 of the present disclosure. As shown in FIG. 11, the present embodiment has a configuration in which the analysis content classification unit 190 is added to the plant operation assistance device shown in Embodiment 3. The analysis content classification unit 190 is configured between the analysis result database 230 and the data selection history database 220, and the analysis procedure creation unit 130.

The analysis content classification unit 190 is a function of classifying the evaluation values in each operation procedure, calculated by the analysis method recorded in the analysis result database 230 by analysis method. For example, it is assumed that in Procedure 1 and Procedure 2, the evaluation values are calculated using the center of gravity and the regression equation as the analysis method, in Procedure 3, the evaluation value is calculated using only the center of gravity as the analysis method, and these are recorded in the analysis result database 230. The analysis content classification unit 190 classifies the evaluation values by analysis method, that is, by the analysis method name information 420. In other words, the evaluation values of Procedures 1 to 3 are those using the center of gravity for the analytical method, and the evaluation values of Procedures 1 and 2 are those using the center of gravity for the analytical method.

In this way, by comparing the items of the analysis method name information 420 recorded in the analysis result database 230 with each other, it is easy to determine in which procedure the analysis methods are switched. The guidance display of information on the evaluation values classified by analysis method by the analysis content classification unit 190 is performed using the division by the analysis method selection operation, in addition to the division by the data selection operation shown in FIG. 5; this makes it easier to grasp the entire analysis work, and thus improvement in the work efficiency can be expected.

As described above, when the analysis procedure is displayed, the classification is performed in combination with the change operation of the analysis content in addition to the data selection operation, so that it is possible to comprehensively grasp a series of analysis works as to which data is selected by the operator and which analysis method is used to perform the quantitative evaluation. Thus, the operator can review the past analysis operation at any timing, and can comprehensively understand the past work content and tendency.

### DESCRIPTION OF SYMBOLS

100: input/output device
101: processor
102: memory
103: display
104: input interface
110: data selection means
120: selection information collection unit
130: analysis procedure creation unit
140: data analysis graph creation unit
150: display data collection unit
160: display data switching unit
170: analysis execution means
180: analysis result collection unit
190: analysis content classification unit
200: measurement data database
210: data selection database
220: data selection history database
230: analysis result database
300, 400: data selection history ID
310: display data information
320, 410: data selection ID
330: data selection content information
340: data selection range information
420: analysis method name information
430: analysis result information
500A to 500C: data selection procedure display
510A to 520B: data selection procedure display with data selection range
600A to 600C: scatter diagram display data consisting of measurement values A and measurement values B
610A to 610C: scatter diagram display data consisting of measurement values A and measurement values C
710: trend graph display example
720: scatter diagram

1.-6. (canceled)

7. A plant operation assistance device comprising:
data selection circuitry for an operator to select an arbitrary data range of a first graph in the first graph and a second graph displayed on a display to be operated by the operator;
a data selection database to record operation information of the operator including the selection of the data range performed through the data selection circuitry;
a measurement data database to accumulate measurement data measured by a measurement device;
a data selection history database to record a history of the operation information performed through the data selection circuitry;
a processor to execute a program; and
a memory to store the program which, when executed by the processor, performs processes of,
collecting the operation information recorded in the data selection database and the measurement data accumulated in the measurement data database,
creating a data analysis graph in which the data related to operator selected data of the first graph is highlighted in the second graph, by using the operation information and the collected measurement data, and
creating guidance for visualizing and displaying the history recorded in the data selection history database, the guidance indicating the operation information that is operation content and an operation procedure performed by the operator.

8. The plant operation assistance device according to claim 7, wherein the data selection database records the operation information including the selection of the data range performed by the operator in the data analysis graph.

9. The plant operation assistance device according to claim 7, wherein the processor
calculates a correlation between the collected data, and
records the calculated analysis results in an analysis result database.

10. The plant operation assistance device according to claim 8, wherein the processor
calculates a correlation between the collected data, and
records the calculated analysis results in an analysis result database.

11. The plant operation assistance device according to claim 9, wherein the processor collects and links the operation information recorded in the data selection history database and the analysis results recorded in the analysis result database, and performs guidance display thereof.

12. The plant operation assistance device according to claim 10, wherein the processor collects and links the operation information recorded in the data selection history database and the analysis results recorded in the analysis result database, and performs guidance display thereof.

13. The plant operation assistance device according to claim 9, wherein the processor classifies the analysis results recorded in the analysis result database by analysis method.

14. The plant operation assistance device according to claim 10, wherein the processor classifies the analysis results recorded in the analysis result database by analysis method.

15. The plant operation assistance device according to claim 7, wherein the processor continuously displays time-series changes of data by an animation method.

16. The plant operation assistance device according to claim 8, wherein the processor continuously displays time-series changes of data by an animation method.
